(19) United States
(12) Patent Application Publication
(10) Pub. No.: US 2005/0237224 A1
(43) Pub. Date: Oct. 27, 2005

(54) Vehicle navigation and safety systems

(76) Inventor: Bradley L. Gotfried, Sai Kung (HK)

Correspondence Address: AKERMAN SENTERFITT, P.O. BOX 3188, WEST PALM BEACH, FL, 33402-3188, US

(21) Appl. No.: 11/100,342

(22) Filed: Apr. 6, 2005

Related U.S. Application Data
(63) Continuation of application No. 10/431,622, filed on May 7, 2003, now abandoned.

(51) Int. Cl. G08G 1/096

(52) U.S. Cl. 340/929; 340/988; 340/995.13; 340/539.1

(57) ABSTRACT

A vehicle navigation system for alerting a vehicle driver of the presence and status of traffic devices. The vehicle navigation system may alert a driver of the time remaining before a traffic device, such as a traffic light, changes the flow of traffic. The vehicle navigation system may also alert a vehicle driver of traffic devices, such as stop signs and speed limit signs, when the driver is approaching the traffic device. The vehicle navigation system may alert a driver through audible or visual alerts, or both. The vehicle navigation system may include a display screen that may or may not be attached to a vehicle. The vehicle navigation system may also include an in-vehicle alert system enabling vehicle drivers to send alert messages to other vehicle drivers within a close proximity.

### FIELD OF THE INVENTION

This invention is directed generally to vehicle navigation systems, and more particularly, to vehicle navigation systems that provide route information to vehicle drivers.

### BACKGROUND

The flow of vehicular travel is controlled using numerous traffic devices. Traffic lights and signs, such as, stop signs, speed limit signs, school zone signs, dangerous curve signs, and the like have been used to control the flow of traffic. Traffic lights have been used at intersections to control the flow of traffic on intersecting roads for many years. Conventional traffic lights include red lights, yellow lights, and green lights for notifying vehicle drivers of a period of time when the drivers may safely pass through an intersection. The illuminated lights change between green, yellow, and red without warning or notice. The purpose of yellow traffic lights is to notify drivers that the traffic signal will be changing shortly. However, because drivers do not always pay attention, drivers sometimes do not see a traffic signal when the traffic signal switches from a green light to a yellow light. As a result, vehicle drivers often run through red lights because the drivers do not see the traffic light change from green to yellow with enough time to stop before the traffic light changes to red. Running red traffic lights has proven dangerous and has resulted in many unnecessary deaths. Thus, a device is needed for notifying a driver of the existence of a traffic light before the driver enters an intersection and for notifying the driver of the time remaining before the traffic light changes traffic flow.

Traffic devices, such as traffic signs, have been used for years to alert drivers of the presence of navigational hazards such as curves in the road, pedestrians, speed limits and others. Typically, these signs are placed along the roadside and alert vehicle drivers only when drivers see the signs. If a driver does not see the sign on the roadside, then the driver does not know that a navigational hazard exists. Thus, a need exists for a more efficient device for alerting drivers of navigational hazards.

Since the early days of automobile use, horns have been used by drivers to get the attention of nearby vehicles. Drivers use horns for a variety of reasons, such as to show thanks, aggression, or to get a driver's attention. While horns have proven to be a convenient device for getting the attention of a nearby vehicle driver, the noise produced by horns is often bothersome. Specifically, in intersections and other areas susceptible to vehicle congestion, horns are used frequently and add substantially to the noise pollution in those areas, which in turn reduces the quality of life in those areas. Thus, a need exists for device for getting the attention of nearby vehicle drivers without creating noise pollution in the process.

### SUMMARY OF THE INVENTION

This invention is directed to a vehicle navigation system for informing a vehicle driver of road hazards that the driver is approaching and for getting the attention of a nearby vehicle driver. The vehicle navigation system includes a traffic control unit that communicates with a traffic control device for determining the time remaining before the traffic control device changes traffic flow. The traffic control device may be a traffic signal or other such device. The vehicle navigation system may also include a transmitter coupled to the traffic control unit for transmitting at least one signal to a receiver in a vehicle. The signal represents the amount of time remaining before the traffic control device changes traffic flow.

The vehicle navigation system also includes a receiver for receiving at least one traffic signal from the transmitter and configured to be placed in a vehicle. The receiver may further be configured to receive global positioning system (GPS) signals from satellites to determine the location of the vehicle. The position of the vehicle is then used to determine whether the vehicle is located near a traffic device, such as a road sign, which may be a speed limit sign, a stop sign, and the like.

The vehicle navigation system may also include a navigation device for receiving one or more traffic signals from the transmitter and alerting the vehicle driver of the time period remaining before the traffic control device changes traffic flow. The navigation device may also alert the driver of locations of traffic devices. The navigation device may alert a vehicle driver through audible or visual alerts, or both. The navigation device may be composed of a display screen for alerting a vehicle driver. The navigation device may also include one or more speakers for audibly alerting a vehicle driver.

The vehicle navigation system may also include an in-vehicle alert system, which enables a vehicle driver to alert nearby vehicle drivers. The in-vehicle alert system may, in some situations, replace a conventional horn. Instead of alerting a nearby driver with a noise produced outside of a vehicle, the in-vehicle alert system enables a driver to send an alert signal to a driver of another vehicle where the alert signal is delivered as an alert message inside the other vehicle. The alert message may be produced as an visual message or an audible message, or both. By confining the alert message to the inside portion of a vehicle, the outside noise associated with attempting to contact another vehicle nearby may be greatly reduced, if not completely eliminated.

An advantage of this invention is that a vehicle driver is alerted to navigational hazards before the driver encounters the hazard so that the driver can make necessary adjustments, such as reduce the speed of the vehicle, to avoid damaging the vehicle or to avoid unsafe conditions.

Another advantage of this invention is that a vehicle driver knows when a traffic light will change, thereby enabling the vehicle driver to change the speed of the vehicle as necessary.

Yet another advantage of this invention is that a vehicle driver may get the attention of a nearby vehicle driver by sending an alert message that alerts the vehicle driver in the vehicle without a noise being produced outside of the vehicle.

These and other features and advantages of the present invention will become apparent after review of the following drawings and detailed description of the disclosed embodiments.

### BRIEF DESCRIPTION OF THE DRAWINGS

The accompanying drawings, which are incorporated in and form a part of the specification, illustrate preferred embodiments of the presently disclosed invention(s) and, together with the description, disclose the principles of the invention(s). These several illustrative figures include the following:

FIG. 1 is a schematic diagram of a vehicle navigation system;

FIG. 2 is a perspective view of the vehicle system of FIG. 1 installed in a vehicle and in communication with a traffic control device and a GPS satellite;

FIG. 3 is a top plan view of a road intersection; and

FIG. 4 is a partial perspective view of the interior portions of a vehicle having the vehicle navigation system of FIG. 1 installed.

### DETAILED DESCRIPTION OF THE INVENTION

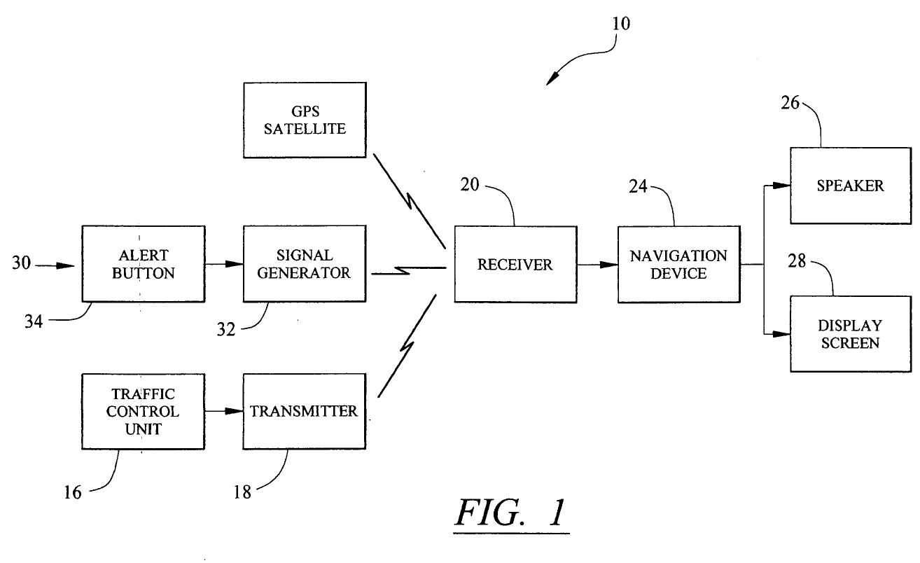

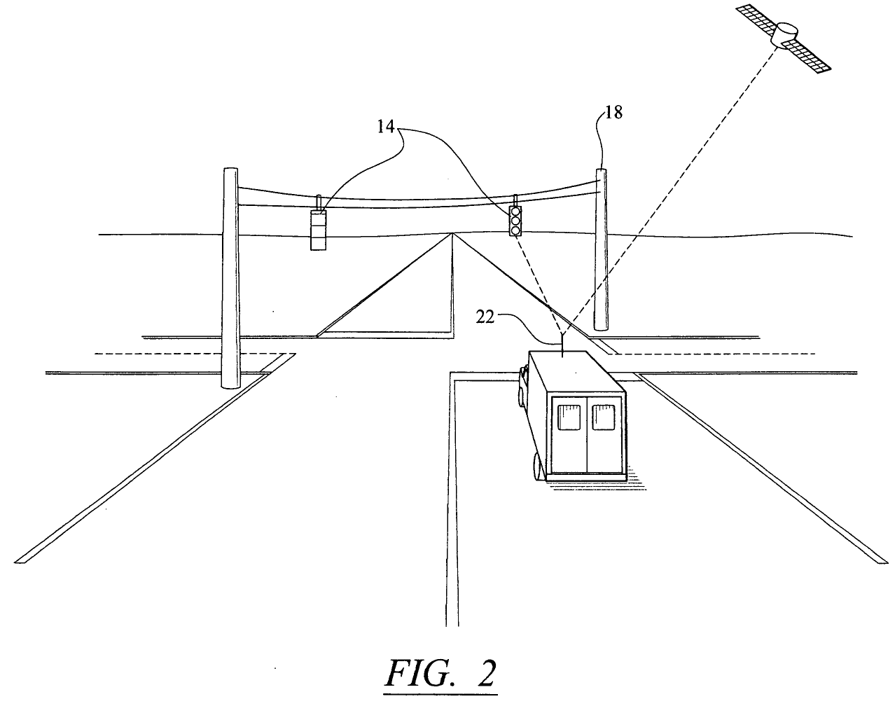

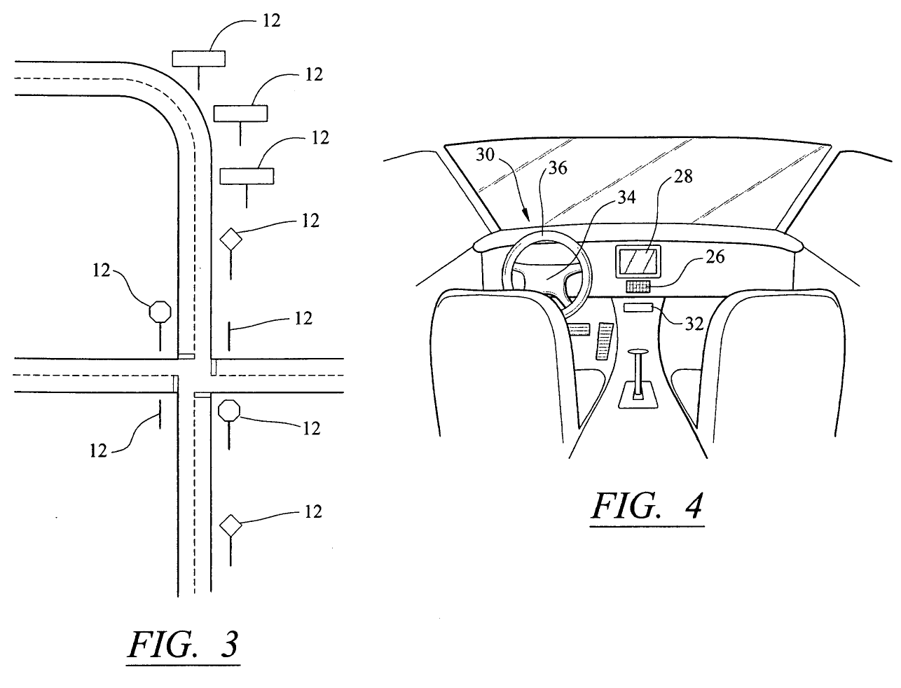

FIG. 1 shows a vehicle navigation system 10 for keeping drivers of vehicles apprised of traffic devices 12 and of traffic control devices 14 that the vehicles are approaching, as shown in FIGS. 2 and 3. The vehicle navigation system 10 can handle numerous tasks. For instance, vehicle navigation system 10 can communicate with a traffic control device 14 to determine when the traffic control device 14 will change the flow of vehicular traffic. The vehicle navigation system 10 may also alert drivers of approaching traffic devices 12, which may be road signs, to warn the driver of, for instance, changes in speed limits or dangerous curves. The vehicle navigation system 10 may also allow drivers to alert nearby drivers using an in-vehicle alert system in place of, or in addition to, a conventional car horn.

The vehicle navigation system 10 may include a traffic control unit 16 in communication with a traffic control device 14. In one embodiment, the traffic control device 14 is a conventional traffic light, as shown in FIG. 2. However, the traffic control device 14 is not limited to a conventional traffic light. Rather, the traffic control device 14 may be other traffic control devices, such as, but not limited to, traffic lights controlling traffic flow at special events, emergency traffic signals controlling traffic and enabling emergency vehicles to safely enter a roadway, and other such devices. The traffic control unit 16 may be in communication with traffic control device 14 through wireless or wired communication systems. The traffic control unit 16 interfaces with the control systems of the traffic control device 14 and determines the amount of time remaining before the traffic control device 14 changes the flow of traffic. If the traffic control device 14 is a conventional traffic signal, the flow of traffic is changed when the light changes from green to red, or vice versa.

The traffic control unit 16 may be formed from many devices. In one embodiment, traffic control unit 16 includes one or more microcontrollers for determining the time remaining before a traffic control device 14 changes its signal, which thereby changes the flow of traffic. The traffic control unit 16 is in communication with a transmitter 18 for transmitting at least one signal to a receiver 20. The transmitter 18 communicates with receiver 20 using wireless communications, such as conventional RF technology, or other wireless technologies. Transmitter 18 should be positioned relative to a road so that a receiver 20 mounted to a vehicle is capable of receiving communications from transmitter 18 before a vehicle containing the receiver 20 passes the traffic control device 14 to which the transmitter 18 is attached. Transmitter 18 could be attached to, for instance, a traffic control device 14, a pole supporting traffic control device 14, or other item.

Vehicle navigation system 10 also includes a receiver 20. Receiver 20 may receive one or more traffic signals from transmitter 18. Receiver 20 may be configured to be permanently attached to a vehicle. For instance, in one embodiment, receiver 20 may be installed in the dash of a vehicle and may include an antenna 22 for increasing the quality of the reception. Antenna 22 may be permanently or releasably mounted to interior or exterior surfaces of a vehicle.

Vehicle navigation system 10 also includes a navigation device 24 for receiving one or more signals from the receiver 20 and alerting a vehicle driver of numerous approaching navigational concerns. For instance, navigation device 24 may alert a vehicle driver of a time period remaining before a traffic control device 14, such as a traffic light, changes traffic flow. Navigation device 24 may audibly or visually alert the driver. Navigation device 24 may audibly alert the driver through a speaker 26 permanently or releasably attached to a vehicle, as shown in FIG. 4. Navigation device 24 may communicate with the speakers installed by the manufacturer as a part of the stereo system. In another embodiment, an auxiliary speaker 26 may be coupled to navigation device 24. The auxiliary device may or may not be permanently attached to a vehicle.

Navigation device 24 may also include a display screen 28 for displaying alerts and other features, as shown in FIG. 4. The display screen 28 may be permanently or releasably attached to a vehicle, or not attached to the vehicle at all. Display screen 28 may have any shape or style; however, display screen 28 should be displayed in a vehicle so that either the driver and possibly passengers in the vehicle can view the screen. Display screen 28 may display numerous pages, which may be changed by touching the screen or by depressing one of several buttons in the vehicle. These buttons may be located in various locations, such as, but not limited to, on a steering wheel, on a dash, on a control panel, on a console between the driver's and front passenger's seats, or other such location.

In one embodiment, display screen 28 can display the amount of time remaining before a traffic control device 14 changes traffic flow. This time period may be displayed in various units of time, but preferably is displayed in seconds. The display of the time period may be displayed on the entire display screen 28 or just a portion of display screen 28. Vehicle navigation system 10 may be configured to display the time remaining before a traffic control device 14 changes traffic flow and audibly alerts a driver of the amount of time remaining. Vehicle navigation system 10 may be configured to give the driver the ability to choose whether the driver receives an alert audibly, visually, or in both manners. In addition, vehicle navigation system 10 may include a device, such as a switch that may or may not be on display screen 28, for turning the system on and off.

Receiver 20 may also be configured to receive GPS signals from satellites to determine the location of a vehicle in which receiver 20 is installed. The GPS signals are sent to navigation device 24 to be processed. Navigation device 24 processes the GPS signal to determine the location of the vehicle in which receiver 20 is located. Once the navigation device 24 determines the location of the vehicle, navigation device 24 determines the proximity of the vehicle to other traffic devices 12. Traffic devices 12 include, but are not limited to, stop signs, speed limit signs, reduced speed limit signs, school crossing signs, dangerous curve ahead signs, slippery road surface signs, lane ends signs, and other such traffic devices.

Navigation device 24 determines the proximity of the vehicle to such traffic devices 12 and alerts a driver of the traffic device 12. Alerting vehicle drivers of traffic devices increases the awareness of drivers and creates a safer environment for operating vehicles. For example, as a driver approaches a traffic device 12 reducing a speed limit from 55 miles per hour (mph) to 45 mph, the navigation device 24 would alert the driver of this change in speed limit. The navigation device 24 alerts a driver that the driver is approaching a specific traffic device 24 once the driver is closer to the traffic device than a predetermined threshold distance. This distance may be, for instance, 45 feet. This threshold distance may vary based on the speed limit of the road proximate to the traffic device 12. For instance, navigation device 24 may alert a driver traveling on a road having a speed limit of 55 mph when the driver is less than 200 feet from the traffic device 12, while the navigation device 24 may alert a driver traveling on a road having a speed limit of 35 mph when the driver is less than about 100 feet from the traffic device 12 so that the driver will have enough time to adjust the speed of the vehicle accordingly.

The latitudinal and longitudinal coordinates for each traffic device 12 may be stored in navigation device 24 in a database which may, for instance, be a removable chip. The database may be updated periodically to keep the location of traffic devices 12 up to date. In another embodiment, navigation device may be adapted to communicate with a central database that stores the location of traffic devices and transmits their location to each navigation device 24. The central database is not located in individual vehicles, but is located in a building remote from the vehicle.

The driver may be alerted using audible or visual alerts, or both. Audible alerts may be a specific sound or combination of sounds that identify to a driver that the driver is approaching a particular type of traffic device 12. For instance, one high pitch beep could signify a change in speed limit and two beeps could signify a stop sign. The audible alerts may also be a voice, such as a computer generated voice or a recorded voice, that alerts a driver that the driver is approaching traffic device 12 by telling the driver what type of traffic device 12 the driver is approaching. The audible alerts may be in English, Spanish, German, Italian, Japanese, or other language.

The display screen 28 may alert a driver that the driver is approaching a traffic device 12. The display screen 28 may display a roadmap and allow a user to zoom in or zoom out using physical or touch screen keys. The roadmap may show traffic devices 12 as represented by symbols that may or may not resemble the traffic device 12 that each symbol represents. The display screen 28 may alert a driver by flashing a message on the screen.

Vehicle navigation system 10 may also include an in-vehicle alert system 30 enabling a vehicle driver to alert nearby vehicle drivers. In-vehicle alert system 30 may operate as a substitute for a conventional horn. In this embodiment, in-vehicle alert system 30 eliminates noise pollution caused from vehicle horns, increases driver awareness and increases driver reaction time. In another embodiment, in-vehicle alert system 30 may be used in addition to conventional vehicle horns.

In-vehicle alert system 30 may include a signal generator 32 for generating alert signals. The alert signal may be a RF signal or other appropriate type of signal. Signal generator 32 may be controlled with an alert button 34. Alert button 34 may be coupled to a vehicle steering wheel 36 in a fashion similar to a conventional horn actuation button. In other embodiments, alert button 34 may be located in other areas of a vehicle or coupled to other components of the vehicle. Alert button 34 may have any shape not interfering with a vehicle driver or operation of the vehicle. Alert button 34 may cause signal generator 32 to generate a signal by depressing alert button 34.

In-vehicle alert system 30 may include receiver 20 for receiving alert signals generated by signal generator 32 in another vehicle. Receiver 20 may be in communication with speaker 26 and display screen 28. In-vehicle alert system 30 operates by receiving an alert signal and communicating the alert signal as an alert message to a vehicle driver using a navigation device. The navigation device may include, but is not limited to, speaker 26 or display screen 28. The alert signal may be communicated in a vehicle as an audio message using speaker 26, or as a visual message displayed on display screen 28, or as a combination of an audio and visual message. The type of message displayed in a vehicle may be changed by a vehicle driver.

In another embodiment, in-vehicle alert system 30 may be used to get the attention of drivers in nearby vehicles in other ways. Specifically, signal generator 32 may be coupled to the electrical system of the vehicle in which the signal generator is mounted so that when a driver depresses an alert button 34 in the vehicle, in-vehicle alert system 30 causes the headlights of the vehicle in which the in-vehicle alert system is mounted to flash on and off. In-vehicle alert system 30 may alternatively cause the parking lights, or other lights on the vehicle, to flash on and off.

The alert signal can operate as a replacement to a conventional horn. When a first driver needs to get the attention of a second driver, such as when the second driver pulls out in front of the first driver, the first driver may push alert button 34. Depressing alert button 34 causes signal generator 32 to generate an alert message. The strength of the signal may vary. In one embodiment, signal generator 32 generates a signal that may be received by vehicles having in-vehicle alert system 30 installed and located within about 100 feet of the signal generating vehicle. In other embodiments, signal generator 32 may generate a signal that may be received by other vehicles at distances greater than about 100 feet or at maximum distances that are less than 100 feet.

All vehicles having an in-vehicle alert system 30 that receive an alert signal alert the occupants of the vehicles of the alert signal. Specifically, in-vehicle alert system 30 generates an audible alert message, a visual alert message, or an audible and visual alert message that is presented inside the vehicle so that unwanted noise is not generated outside of the vehicle. In-vehicle alert system 30 may have the capability of being turned off so that when other nearby vehicles generate alert signals, the in-vehicle alert system 30 in the vehicle having the system turned off does not generate an alert message.

The foregoing is provided for purposes of illustrating, explaining, and describing embodiments of this invention. Modifications and adaptations to these embodiments will be apparent to those skilled in the art and may be made without departing from the scope or spirit of this invention.

1. A vehicle navigation system, comprising:
a traffic control unit in communication with a traffic control device for determining time remaining before the traffic control device changes traffic flow;
a transmitter coupled to the traffic control unit for transmitting at least one signal to a receiver, wherein the signal represents the amount of time remaining before the traffic control device changes traffic flow;
a receiver in communication with the traffic control unit for receiving at least one traffic signal from the transmitter and for receiving global positioning system signals;
a navigation device in communication with the receiver for receiving the at least one traffic signal from the transmitter, alerting a driver of the time period remaining before the traffic control device changes traffic flow, and alerting the driver of locations of traffic devices; and
an in-vehicle alert system, having a signal generator for generating radio frequency alert signals and sending the radio frequency alert signals directly to a second vehicle and a receiver for receiving at least one radio frequency alert signal directly from at least one second vehicle.

2. The vehicle navigation system of claim 1, wherein the traffic control unit and transmitter are included in the traffic control device.

3. The vehicle navigation system of claim 1, wherein the traffic control device is a stop light.

4. The vehicle navigation system of claim 1, wherein the device for alerting a driver of the time period remaining before the traffic control device changes traffic flow comprises a speaker for audibly alerting the driver as to the amount of time remaining before the traffic control device changes the traffic flow.

5. The vehicle navigation system of claim 1, wherein the device for alerting a driver of the time period remaining before the traffic control device changes traffic flow comprises a display device for visually alerting the driver as to the amount of time remaining before the traffic control device changes the traffic flow.

6. The vehicle navigation system of claim 5, wherein the display device displays the amount of time remaining before the traffic control device changes using numerals.

7. The vehicle navigation system of claim 5, wherein the display device displays the amount of time remaining before the traffic control device changes using a clock dial.

8. (canceled)

9. A vehicle navigation system, comprising:
a traffic control unit in communication with a traffic control device for determining time remaining before the traffic control device changes traffic flow and for providing proximate upcoming travel conditions to alert the driver;
a transmitter coupled to the traffic control unit for transmitting at least one signal to a receiver, wherein the signal represents the amount of time remaining before the traffic control device changes traffic flow and proximate upcoming travel conditions;
a receiver in communication with the traffic control unit for receiving at least one traffic signal from the transmitter, and
a navigation device in communication with the receiver for receiving the at least one traffic signal from the transmitter and alerting a driver of the time period remaining before the traffic control device changes traffic flow and to the proximate upcoming travel conditions.

10. The vehicle navigation system of claim 9, wherein the traffic control unit and transmitter are included in the traffic control device.

11. The vehicle navigation system of claim 9, wherein the traffic control device is a stop light.

12. The vehicle navigation system of claim 9, wherein the device for alerting a driver of the time period remaining before the traffic control device changes traffic flow comprises a speaker for audibly alerting the driver as to the amount of time remaining before the traffic control device changes the traffic flow.

13. The vehicle navigation system of claim 9, wherein the device for alerting a driver of the time period remaining before the traffic control device changes traffic flow comprises a display device for visually alerting the driver as to the amount of the remaining before the traffic control device changes the traffic flow.

14. The vehicle navigation system of claim 13, wherein the display device displays the amount of time remaining before the traffic control device changes using numerals.

15. The vehicle navigation system of claim 9, further comprising an in-vehicle alert system, having a signal generator for generating radio frequency alert signals and sending the radio frequency alert signals directly to a second vehicle a receiver for receiving at least one radio frequency alert signal directly from at least one second vehicle.

16. A vehicle navigation system, comprising:
a signal generator for generating radio frequency alert signals and sending the radio frequency alert signals directly to a second vehicle;
a receiver for receiving at least one radio frequency alert signal directly from at least one second vehicle; and
a navigation device in communication with the receiver for alerting a driver of a vehicle of the at least one alert signal.

17. The vehicle navigation system of claim 16, wherein the navigation device comprises a speaker for audibly conveying the alert signal to the driver.

18. The vehicle navigation system of claim 16, wherein the navigation device comprises a display device for visually alerting the driver of the alert signal.

19. The vehicle navigation system of claim 16, wherein the navigation device comprises a speaker for audibly conveying the alert message to the driver and a display device for visually alerting the driver of the alert message.

20. The vehicle navigation system of claim 16, further comprising a switch for turning the vehicle navigation system off.
